(19) United States
(12) Patent Application Publication
(10) Pub. No.: US 2008/0063424 A1
(43) Pub. Date: Mar. 13, 2008

(54) Image forming apparatus, print control apparatus, and print control method

(75) Inventors: Kazuyoshi Tanaka, Tokyo (JP); Koji Kita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/812,918

(22) Filed: Jun. 22, 2007

(30) Foreign Application Priority Data
Sep. 13, 2006 (JP) JP2006-247810

(51) Int. Cl. G03G 21/02

(52) U.S. Cl. 399/79

(57) ABSTRACT

In a print control system including image forming apparatus equipped with print device, sheet supply device with sheet supply counters and sheet ejection device with a sheet ejection counter, sheet number information including the number of supplied sheets from each tray based on values of respective sheet supply counters or the number for each sheet type based on the values of the counters and correlating information between a tray and a sheet type, and the number of ejected sheets based on the value of sheet ejection counter is acquired for each job, then, suitability of print is determined by comparing the total of numbers of supplied sheets for each tray or for each sheet type with the number of ejected sheets, and from these pieces of information, control information that can be used on a communication network is generated to be referred by a terminal for loss control.

This application is based on Japanese Patent Application No. 2006-247810 filed on Sep. 13, 2006 in Japanese Patent Office, the entire content of which is hereby incorporated by reference.

### BACKGROUND OF THE INVENTION

The present invention relates to an image forming apparatus, a print control apparatus that controls printing in the image forming apparatus and to a print control method.

A copying machine and a multifunctional machine each having therein a copying function, a facsimile function, a printer function and a scanner function (hereinafter referred to as an image forming apparatus as a general name) are widely prevalent. This image forming apparatus is equipped with a printing device that conducts printing on a sheet, a sheet supply device that feeds a sheet to the printing device and a sheet ejection device that ejects the sheet which has been subjected to printing, and a sheet supply counter that counts supplied sheets is provided on the sheet supply device, and a sheet ejection counter that counts ejected sheets is provided on the sheet ejection device, thus, sheet jam is controlled based on the counted numbers of the sheet supply counter and the sheet ejection counter.

For example, methods to control sheet jam by recording a difference of counted number between the sheet supply counter and the sheet ejection counter and methods to display these pieces of information through a network with outer systems are disclosed in the following Patent Documents 1-6.

However, in the past, there has been a problem that the image forming apparatus cannot be controlled precisely because of processing that has been carried out based on the total number of the supplied sheets and ejected sheets of an image forming apparatus.

In recent years, for example, printing is conducted not only for ordinary copy sheets but also for special sheets such as sheets having different sheet quality and different sheet thickness as well as water marked sheets, in many cases. Besides, a unit cost of these special sheets are high, and therefore, it has been desired that a loss such as sheet jam is controlled precisely. However, it has been impossible to find out the sheet on which a loss has occurred, and precise control of the number of sheets (loss control) has been impossible, because nothing has been known except the total number of supplied sheets and ejected sheets for the apparatus.

Further, the sheet supply device and the sheet ejection device of the image forming apparatus are equipped with a complicated conveyance mechanism for conveying sheets, and sheet jam has occurred in various locations of the conveyance mechanism. However, in the past, it has been impossible to find out a tray from which the sheet on which a loss has occurred was conveyed, and precise control of the number of sheets (loss control) has been impossible, because nothing has been known except the total number of supplied sheets and ejected sheets for the apparatus.

[Patent Document 1] Japanese Patent Publication Open to Public Inspection No. 2001-180097

[Patent Document 2] Japanese Patent Publication Open to Public Inspection No. 2002-244493

[Patent Document 3] Japanese Patent Publication Open to Public Inspection No. 2002-347318

[Patent Document 4] Japanese Patent Publication Open to Public Inspection No. 2005-91739

[Patent Document 5] Japanese Patent Publication Open to Public Inspection No. 2006-35756

[Patent Document 6] Japanese Patent Publication Open to Public Inspection No. 1-127369

### SUMMARY

The present invention has been attained in view of the aforesaid problems, and its main objective is to provide an image forming apparatus, a print control apparatus and a print control method which make it possible to control simply and precisely. In particular, to provide an image forming apparatus, a print control apparatus and a print control method which make it possible to control the number of sheets for each tray and for each type of a sheet.

To attain the aforesaid objective, the invention is represented by an image forming apparatus that is equipped with at least a sheet supply device that supplies sheets from each of plural trays, a printing device that prints on the aforesaid sheet based on a job and a sheet ejection device that ejects the aforesaid printed sheet to a sheet ejection position, wherein, plural sheet supply counters each counting the number of the aforesaid sheets supplied from each tray are arranged on the sheet supply device, and a sheet ejection counter that counts the number of the aforesaid sheets ejected is arranged on the sheet ejection device, and there is provided a device that acquires at least the number of sheets from each tray calculated based on the value of each sheet supply counter and the number of sheets ejected calculated based on the value of the sheet ejection counter for each job.

The present invention is represented by an image forming apparatus that is equipped with at least a sheet supply device that supplies sheets from each of plural trays, a printing device that prints on the aforesaid sheet based on a job and a sheet ejection device that ejects the aforesaid printed sheet to a sheet ejection position, wherein, plural sheet supply counters each counting the number of the aforesaid sheets supplied from each tray are arranged on the sheet supply device, and a sheet ejection counter that counts the number of the aforesaid sheets ejected is arranged on the sheet ejection device, and there are provided a device that stores correlating information which makes each tray and a sheet type of the sheets loaded on the tray to correspond each other, and a device that acquires, for each job, at least the number of supplied sheets for each sheet type calculated based on the value of each sheet supply counter and on the aforesaid correlating information and the number of ejected sheets calculated based on the value of the sheet ejection counter.

In the present invention, a tray, a sheet type and a user which are to be controlled are registered in advance, and it is possible to create the constitution to acquire the aforesaid information of the number of sheets when the tray or the sheet type to be designated in the aforesaid job or the user who practices the aforesaid job has been registered, or the constitution to acquire the aforesaid information of the number of sheets when the tray, the sheet type or the user which are not to be controlled is registered in advance and when the tray or the sheet type to be designated in the aforesaid job or the user who practices the aforesaid job has not been registered.

Further, in the present invention, it is also possible to create the constitution which is further equipped with a step to judge presence of print failure based on whether the total number of sheets supplied from each tray or sheets of each sheet type and aforesaid number of ejected sheets agree with each other or not, and a step to prepare control information including the aforesaid number of supplied sheets from each tray or of each sheet type, the total number of sheets, the number of ejected sheets and results of the judgment for each tray or for each sheet type.

Further, the present invention includes a print control apparatus that controls one or plural image forming apparatuses each having a plurality of trays, and it is equipped with a step to receive, from the image forming apparatus, at least the number of supplied sheets for each tray and the number of ejected sheets, and a step to judge presence of print failure based on whether the total of numbers of sheets supplied from each tray and the number of ejected sheets agree with each other or not, and a step to prepare control information including the aforesaid number of supplied sheets from each tray, the total number of sheets, the number of ejected sheets and results of the judgment.

Further, the present invention includes a print control apparatus that controls one or plural image forming apparatuses each having a plurality of trays, and it is equipped with a step to receive from the image forming apparatus at least the number of supplied sheets of each sheet type and the number of ejected sheets, and a step to judge presence of print failure based on whether the total of numbers of supplied sheets of each sheet type and the number of ejected sheets agree with each other or not, and a step to prepare control information including the aforesaid number of supplied sheets of each sheet type, the total number of sheets, the number of ejected sheets and results of the judgment.

Further, the invention includes a print control method in a system including one or plural image forming apparatuses each having at least a sheet supply device which supplies sheets from each of plural trays and is equipped with plural sheet supply counters each counting the number of the sheets supplied from each tray, a printing device that prints on the sheet based on the job and a sheet ejection device which ejects the printed sheet to the ejection position and is equipped with a sheet ejection counter that counts the number of sheets to be ejected, wherein there are provided at least a step to acquire the number of supplied sheets from each tray calculated based on the value of each sheet supply counter and the number of ejected sheets calculated based on the value of the sheet ejection counter for each job, a step to judge presence of print failure based on whether the total of numbers of supplied sheets from each tray and the number of ejected sheets agree with each other or not, and a step to prepare control information including the aforesaid number of supplied sheets from each tray, the total number of sheets, the number of ejected sheets and results of the judgment, and thereby, the number of sheets for each tray is controlled by making the control information to be capable of being utilized by the terminal that is connected to the image forming apparatus through a communication network.

Further, the invention includes a print control method in a system including one or plural image forming apparatuses each having at least a sheet supply device which supplies sheets from each of plural trays and is equipped with plural sheet supply counters each counting the number of the sheets supplied from each tray, a printing device that prints on the sheet based on the job and a sheet ejection device which ejects the printed sheet to the ejection position and is equipped with a sheet ejection counter that counts the number of sheets to be ejected, wherein there are provided at least a step to store correlating information which makes each tray and a sheet type of the sheets loaded on the tray to correspond to each other, a step to acquire the number of supplied sheets of each sheet type calculated based on the value of each sheet supply counter and on the aforesaid correlating information and the number of ejected sheets calculated based on the value of the sheet ejection counter, a step to judge presence of print failure based on whether the total of numbers of supplied sheets of each sheet type and the number of ejected sheets agree with each other or not, and a step to prepare control information including the aforesaid number of supplied sheets of each sheet type, the total number of sheets, the number of ejected sheets and results of the judgment, and thereby, the number of sheets of each sheet type is controlled by making the control information to be capable of being utilized by the terminal that is connected to the image forming apparatus through a communication network.

### BRIEF DESCRIPTION OF THE DRAWINGS

FIG. 1 is a diagram showing schematically the structure of a control system relating to the First Example of the invention.

FIG. 2 is a diagram showing an example of a construction of an image forming apparatus relating to the First Example of the invention.

FIG. 3 is a block diagram showing the structure of an image forming apparatus relating to the First Example of the invention.

FIG. 4 is a block diagram showing the structure of a print control apparatus relating to the First Example of the invention.

FIG. 5 is a diagram showing schematically another structure of a control system relating to the First Example of the invention.

FIG. 6 is a block diagram showing another structure of an image forming apparatus relating to the First Example of the invention.

FIG. 7 is a flow chart diagram showing procedures of processing in an image forming apparatus relating to the First Example of the invention.

FIG. 8 is a flow chart diagram showing procedures of processing in an print control apparatus relating to the First Example of the invention.

FIG. 9 is a diagram showing an example of the structure of control information prepared by a print control apparatus relating to the First Example of the invention.

FIG. 10 is a flow chart diagram showing procedures of processing in an image forming apparatus relating to the Second Example of the invention.

FIG. 11 is a flow chart diagram showing procedures of processing in a print control apparatus relating to the Second Example of the invention.

FIG. 12 is a diagram showing an example of the structure of control information prepared by a print control apparatus relating to the Second Example of the invention.

### DETAILED DESCRIPTION OF THE PREFERRED EMBODIMENT

As stated above, a sheet supply counter is provided on a conveyance path from each tray of a sheet supply device of the image forming apparatus, then, the number of supplied sheets for each tray or for each sheet type and the number of ejected sheets are acquired on a job unit, and the number of supplied sheets is compared with the number of ejected sheets in the image forming apparatus or in the print control apparatus to decide whether printing is proper or not, and results of the decision are made to be capable of being utilized by the outer terminal, thus, the number of sheets can be controlled simply and precisely.

The detailed embodiments will be described as follows.

In the printing business field, there are sometimes conducted the so-called additional printing wherein an expensive sheet (such as documents of securities) is used as a print sheet on which an additional output is formed through copy printing. In this case, it is necessary to calculate the number of sheets accurately for losses by sheet jam and for intentional sheet extraction and to make the normal number of sheets to be outputted, the number of remaining sheets and the number of sheets of losses to be consistent with each other, because the original sheet is expensive. Further, each of the sheet supply device and the sheet ejection device is equipped with a complicated conveyance mechanism, and there is an occasion where sheet jam tends to be caused on the sheet conveyed from the specific tray due to abrasion of parts. Under these circumstances, if it is possible to know the tray delivering the sheet on which sheet jam has occurred, it is possible to take measures to prevent occurrence of sheet jam in advance.

Therefore, in the present invention, the number of supplied sheets and the number of ejected sheets are counted for each tray or each sheet type, instead of counting the number of supplied sheets and the number of ejected sheets for the entire apparatus, and the results of the counting are controlled, so that an operator may control losses simply. Further, by establishing whether control is conducted or not for each job, each user, each tray and each sheet type in advance, efficient loss control may be carried out.

Specifically, in an image forming apparatus having therein a printing device that prints on a sheet, a sheet supply device that supplies a sheet to the printing device and a sheet ejection device that ejects the sheet subjected to printing, wherein the sheet supply device is provided with a supplied sheet counter that counts the supplied sheets, and the sheet ejection device is provided with the sheet ejection counter that counts ejected sheets, the supplied sheet counter is provided on a conveyance path from each tray, to make is possible to control the number of sheets printed and the number of sheets of loss for each tray.

Further, correlating information between each tray and a sheet type of sheets loaded on the each tray is stored, to make it possible to calculate the number of supplied sheets for each sheet type based on the number of sheets of each tray and the correlating information and to make it possible to control the number of sheets printed and the number of sheets of loss for each sheet type.

Then, whether printing is proper or not is decided based on whether the number of supplied sheets and the number of ejected sheets agree with each other or not, and the control information displaying the number of supplied sheets, the number of ejected sheets and results of the decision for each job as a list is prepared to be utilized by outer terminals, whereby, an operator can control the number of sheets for each tray and for each sheet type, which makes it possible to control the image forming apparatus simply and precisely. Detailed description will be given as follows, referring to the drawings.

### EXAMPLE 1

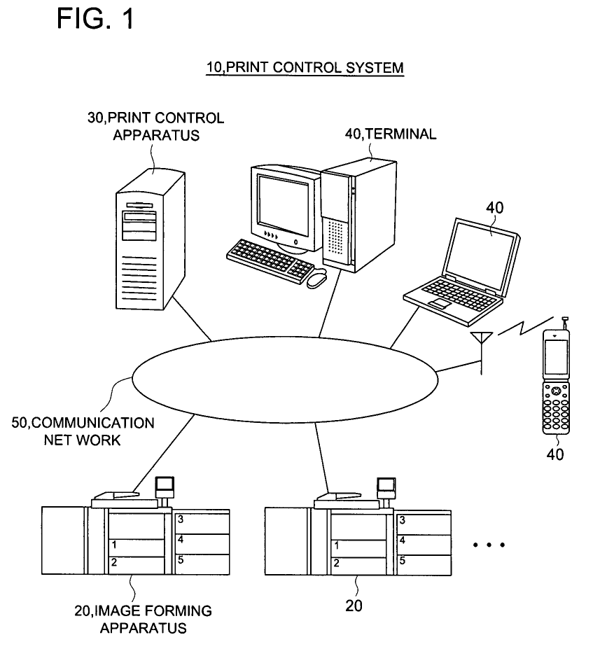

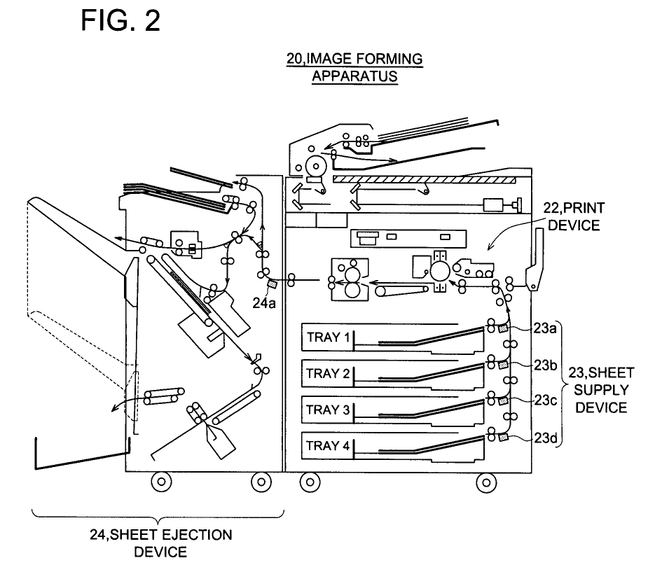

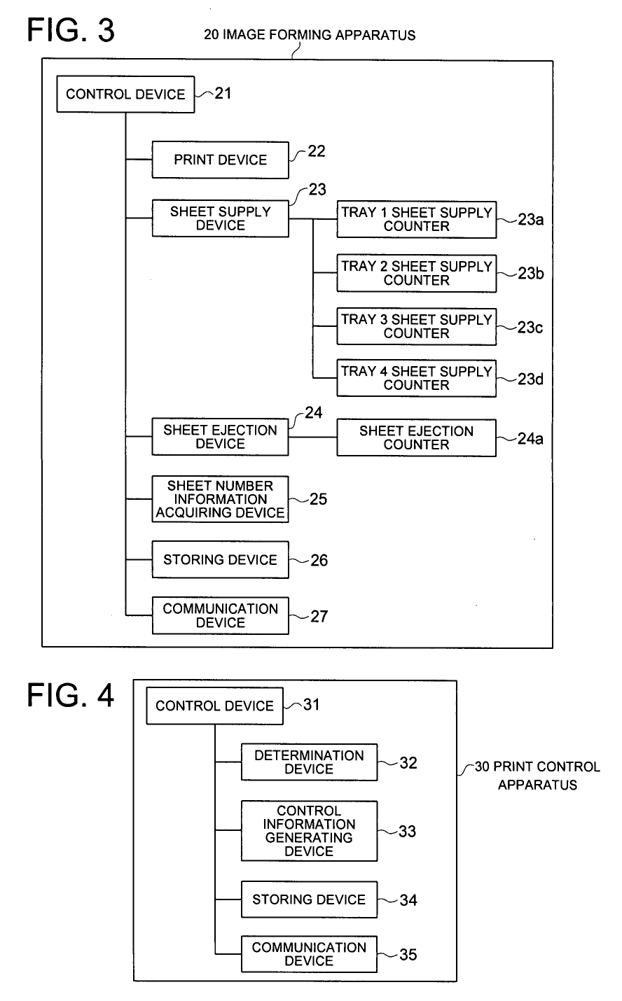

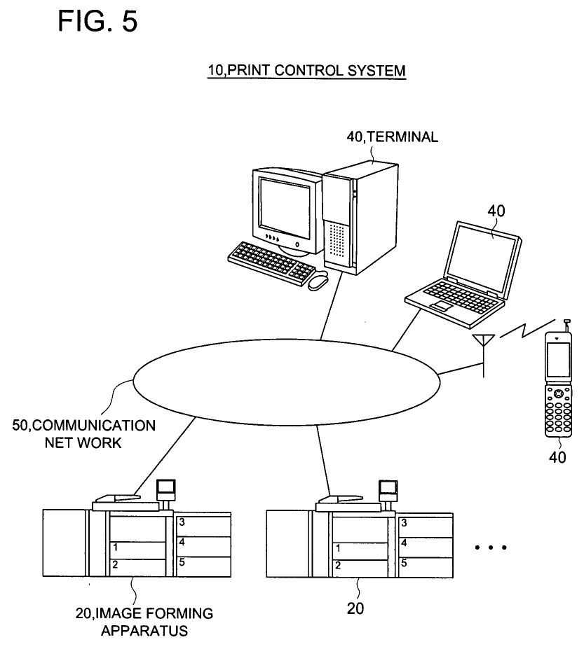

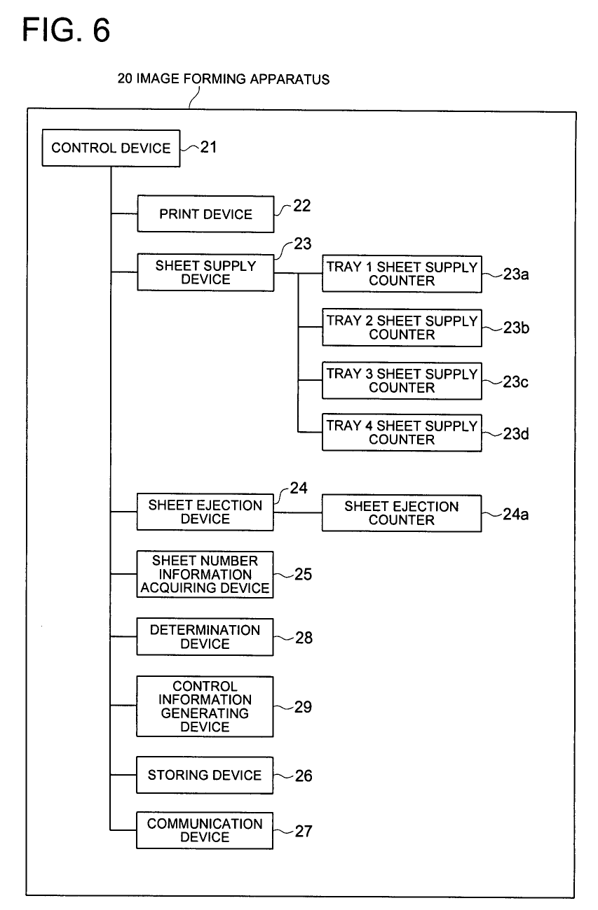

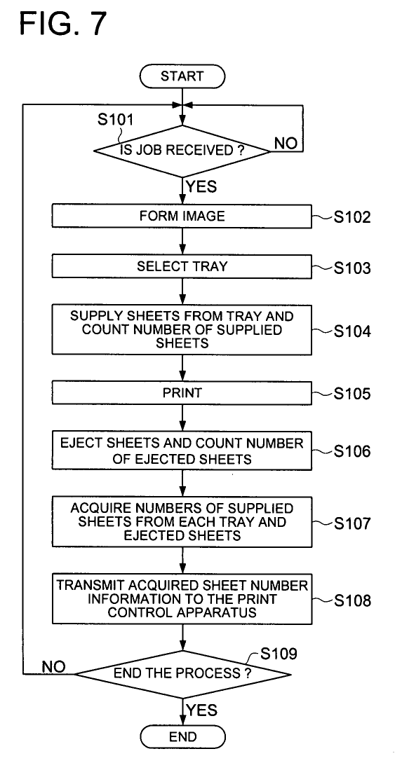

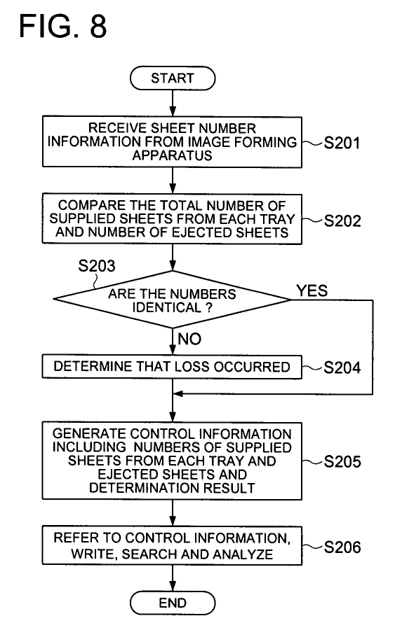

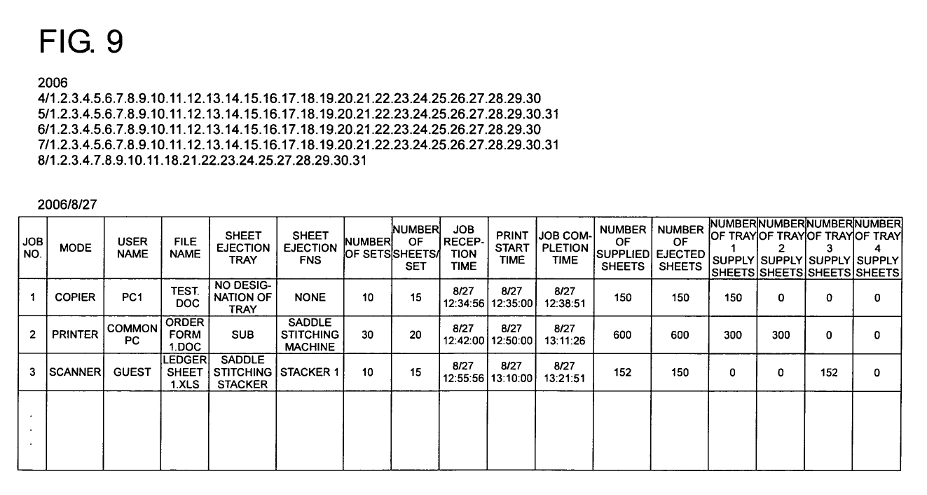

First, an image forming apparatus, a print control apparatus and a print control method all relating to the First Example of the invention will be described, referring to FIG. 1-FIG. 9. Each of FIG. 1 and FIG. 5 is a diagram showing schematically the structure of a control system of the present example, and FIG. 2 is a diagram showing the structure of an image forming apparatus and a conveyance path for sheets of the present example. Each of FIG. 3 and FIG. 6 is a block diagram showing the structure of an image forming apparatus and FIG. 4 is a block diagram showing the structure of a print control apparatus. Further, FIG. 7 is a flow chart diagram showing processing in the image forming apparatus, while, FIG. 8 is a flow chart diagram showing procedures of processing in the print control apparatus. FIG. 9 is a diagram showing an example of the structure of control information.

As shown in FIG. 1, control system 10 of the present example is provided with one or plural image forming apparatuses 20 equipped with a copy function and a facsimile function, a printer function and a scanner function, and with print control apparatus 30 for controlling the image forming apparatus 20, and with one or plural terminals 40 for confirming the state of the image forming apparatus 20, and these are connected to each other through communication network 50 such as LAN (Local Area Network) or WAN (Wide Area Network).

Incidentally, FIG. 1 is an example of control system 10 of the present example, and numbers and forms of the image forming apparatus 20, the print control apparatus 30 and the terminal 40 are optional. For example, the image forming apparatus 20 has only to be an apparatus capable of practicing print processing, and it can be provided with any of a copy function, a facsimile function, a printer function and a scanner function. Further, the print control apparatus 30 may be either an apparatus conducting only calculation processing, or an apparatus equipped with a display device and an operation device. The terminal 40 has only to be an apparatus on which the control information prepared by the print control apparatus 30 can be read, and it can be either a computer equipment, a cell-phone or PDA (Personal Digital Assistant).

Further, as shown in FIG. 2 and FIG. 3, the image forming apparatus 20 of the present example is provided with printing device 22 that forms on image through an electrophotographic method and transfers the image onto a sheet, sheet supply device 23 that is provided with plural trays (four trays in FIG. 2) and supplies a sheet loaded in a prescribed tray to the print device 22, sheet ejection device 24 that ejects the sheet which has been subjected to printing, sheet number information acquiring device 25 that acquires information which includes the numbers of supplied sheets for each tray and ejected sheets and is used for sheet control (hereinafter referred to as sheet number information), storing device 26 such as ROM (Read-Only Memory) or RAM (Random-Access Memory) which stores correlating information that makes each tray and a sheet in the tray to correspond each other, communication device 27 to be connected to communication network 50 and with control device 21 such as CPU (Central Processing Unit) that controls the aforesaid items, and further sheet supply counters 23a . . . (23a-23d in this case) which count the number of sheets to be supplied are provided on the conveyance path from each tray of sheet supply device 23, and sheet ejection counter 24a that counts the number of sheets to be ejected from the print device 22 is provided on the sheet ejection device 24. Incidentally, each of sheet supply counters 23a . . . and sheet ejection counter 24a can be composed of a photosensor and a microswitch, and its detection mechanism and a size are not limited and its furnishing position is not limited to the description in FIG. 2 either.

Further, as shown in FIG. 4, the print control apparatus 30 of the present example is provided with determination device 32 that processes sheet number information transmitted from the image forming apparatus 20 and determines presence of jam (sheet jam) and loss (failure), control information generating device 33 that generates information including sheet number information and aforesaid determination result to be used for control of the image forming apparatus 20 (hereinafter referred to as control information) so that the information may be utilized by terminals 40, storing device 34 such as ROM and RAM which stores sheet number information and control information, communication device 35 to be connected to communication network 50 and control device 31 such as CPU that controls the aforesaid items.

Incidentally, sheet number information acquiring device 25 of image forming apparatus 20 and determination device 32 of print control apparatus 30 and control information generating device 33 may be constituted as hardware for the image forming apparatus 20 and the print control apparatus 30. Further, it may be constituted that a program makes a computer to function as sheet number information acquiring device 25, determination device 32 and control information generating device 33, so that the program may function on the image forming apparatus 20 and the print control apparatus 30. Further, in the present example, each of the determination device 32 and the control information generating device 33 is made to be an independent device for the sake of convenience. However, it is also possible to unite these items as one device, and to add the function of the determination device 32 to the sheet number information acquiring device 25.

Further, although print control device 30 is used to control image forming apparatus 20 in the structure shown in FIG. 1, it is also possible to cause the image forming apparatus 20 to process sheet number information by itself and to generate control information, without providing the print control device 30, as shown in FIG. 5. In that case, the image forming apparatus 20 is constructed as shown in FIG. 6 wherein determination device 28 and control information generating device 29 are added to the structure of FIG. 3.

Procedures of print control employing print control system 10 having the structure shown in FIG. 1 will be described as follows, referring to flow chart diagrams of FIG. 7 and FIG. 8.

First, in step S101 in FIG. 7, control device 21 of image forming apparatus 20 monitors jobs, and when the job is received, images are formed based on job data in step S102. Specifically, a photoconductor drum is irradiated by light of a semiconductor laser based on data to form a latent image thereon, and charging, exposure and development processing are conducted to form a toner image on the photoconductor drum. In this case, incidentally, though an image is formed for the job received through communication device 27, it is also possible to form an image based on, for example, a document placed on a document stand of image forming apparatus 20. In that case, a document is read by the use of an imaging device such as CCD image sensor, and an image may be formed by using data acquired by conducting analog processing, A/D conversion, shading correction and image compression processing for analog signals subjected to photoelectric conversion.

Next, in step S103, the control device 21 selects the tray in which the sheets specified by the job are loaded, based on correlating information stored in storing device 26 in advance.

Next, in step S104, sheet supply device 23 takes out a sheet from the selected tray and conveys it to print device 22. In that case, the number of supplied sheets is counted by sheet supply counters 23a-23d (for example, sheet supply counter 23a when tray 1 is selected) positioned at prescribed locations on the conveyance path from the selected tray.

Next, in step S105, print device 22 transfers a toner image on the photoconductor drum onto the sheet conveyed from sheet supply device 23, and fixes the toner image for printing.

Next, in step S106, sheet ejection device 24 ejects the sheet onto which the image has been transferred to a fixed sheet ejection tray or to a liftable sheet ejection tray, and when conducting post processing such as center-folding or staple (stitching) processing, the sheet ejection device 24 ejects the sheet to a post-processing device. In that case, the number of ejected sheets is counted by sheet ejection counter 24a arranged at the prescribed position on a sheet conveyance path.

Then, when transferring the same image onto plural sheets, processing of step S104 and processing of step S105 are repeated, and when transferring the succeeding image, processing of step S102—processing of S105 are repeated, and the number of supplied sheets and the number of ejected sheets are counted in succession, by sheet supply counters 23a-23d and by sheet ejection counter 24a.

Next, in step S107, sheet number information acquiring device 25 acquires counted values from sheet supply counters 23a-23d, calculates its increased number (a difference from the counted value after completion of the preceding job), then, acquires the number of supplied sheets for each tray and further acquires the counted value from sheet ejection counter 24a, and calculates its increased number (a difference from the counted value after completion of the preceding job) to acquire the number of ejected sheets. Further, information used for control of sheets (for example, information to specify the job and information to specify a user, which will be described later) is acquired in case of need. Incidentally, though the number of sheets for each tray is obtained by providing sheet supply counters 23a-23d on the conveyance path from each tray, in this case, it is also possible to acquire the number of supplied sheets for each tray based on information of the tray selected in step S103 and on the counted value of the sheet supply counter, by providing one sheet supply counter on sheet supply device 23.

After that, in step S108, control device 21 transmits sheet number information including supplied sheet information for each tray and ejected sheet information thus acquired to print control apparatus 30 by using communication device 27, and determines whether to terminate processing or not in step S109, and when the processing is not terminated, the control device 21 returns to step S101, and the same processing is repeated for the succeeding job.

On the other hand, print control apparatus 30 receives sheet number information from image forming apparatus 20 by using communication device 35 in step S201 in FIG. 6, while, determination device 32 compares the total value of numbers of supplied sheets for each tray with the number of ejected sheets in step S202.

Then, in step S203, it is determined that the processing has been terminated normally when the number of supplied sheets and the number of ejected sheets agree with each other, after the comparison. On the other hand, when the number of supplied sheets and the number of ejected sheets do not agree with each other, it is determined that print failures (loss and jam) occurred in step S204. For example, when the number of supplied sheets is 100 and the number of ejected sheets is 100, it can be determined that the processing has been terminated normally, but when the number of supplied sheets is 102 and the number of ejected sheets is 100, it is determined that loss occurred on two sheets.

Next, in step S205, control information generating device 33 totals the sheet number information for the number of sheets transmitted for each job and the results determined by determination device 32, and generates control information shown in FIG. 9. In this control information, there are described information that specifies job for the selected date (job number and mode, sheet ejection tray, sheet ejection finisher (FNS), job-accepting time, print-starting time and job-completing time), information specifying a user (user name) and information specifying the number of sheets (number of supplied sheets from each tray, total number of supplied sheets and the number of ejected sheets), and the number of supplied sheets and the number of ejected sheets of the job determined to have print failures are displayed by changing colors and display forms so that the results of the determination may be discriminated. In the meantime, though information for one image forming apparatus 20 is described in this case, information for plural image forming apparatuses 20 may also be described in a table. The control information thus generated is stored in storing device 34 as control information table for each job.

After that, control device 31 of print control apparatus 30 transmits control information to terminal 40 by using communication device 35, or a user acquires control information by having access to print control apparatus 30 by using terminal 40, to grasp the state of image forming apparatus 20 by referring to the control information. For example, in the example shown in FIG. 9, the number of supplied sheets and the number of ejected sheets for the third job do not agree with each other and the sheet is supplied from tray 3, thus, it is possible to know that print loss occurred on two sheets for the sheets loaded in tray 3. Meanwhile, it is preferable that the control information is structured so that it can be used for writing necessary information in, or for searching the job in which the print loss has occurred and for analyzing, in addition to referring, and it is preferable to be utilized by any terminal 40, thus, for example, the control information can be described in a markup language such as HTML or XML to be read by a browser.

As stated above, in the present example, sheet number information including the number of supplied sheets from each tray obtained from sheet supply counters 23a . . . provided on the conveyance path of each tray and the number of ejected sheets obtained from sheet ejection counter 24a is outputted from image forming apparatus 20, then, occurrence of print loss is determined based on the sheet number information, and control information which can be utilized by terminal 40 is generated, whereby, sheet supply can be controlled for each tray, and sheet number control of image forming apparatus 20 can be carried out simply and precisely.

Though the sheet number information was acquired after an end of the job in the aforesaid description, it is also possible to acquire the information additionally in the case of an interruption of the job that is caused when sheet jam happened or when sheets are used up. Further, in the aforesaid description, there was shown the structure to control the sheet number for each tray by providing a plurality of sheet supply counters 23a. on sheet supply device 23. However, it is also possible to provide a plurality of sheet ejection counters further on sheet ejection device 24. For example, post-processing devices after sheet ejection include a center-folding device, a wrapping-binding machine and a large capacity stacker, and the large capacity stacker has a tandem function wherein the same stackers are connected to be used, and when the number of sheets used exceeds 5000 in one job, the stacker is replaced by the following stacker automatically, if a capacity of each stacker is 5000 sheets. In this case, it is possible to provide a sheet ejection counter on the conveyance path of each stacker, and to convert the information to information indicating that 7000 sheets in total are loaded in stackers, if, for example, 5000 sheets are loaded in stacker 1 and 2000 sheets are loaded in stacker 2, for the reason that the control of the total number of sheets loaded in stackers is easier than that of the number of sheets loaded in each stacker.

### EXAMPLE 2

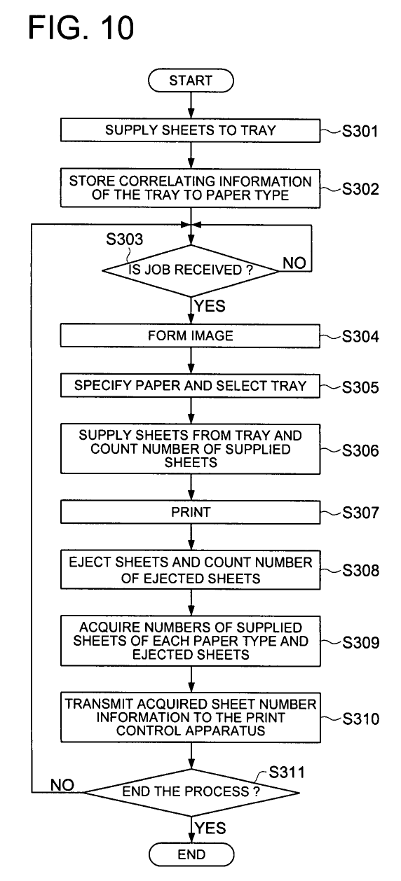

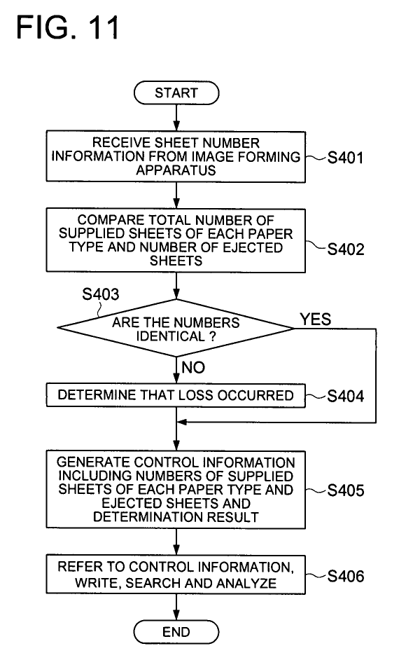

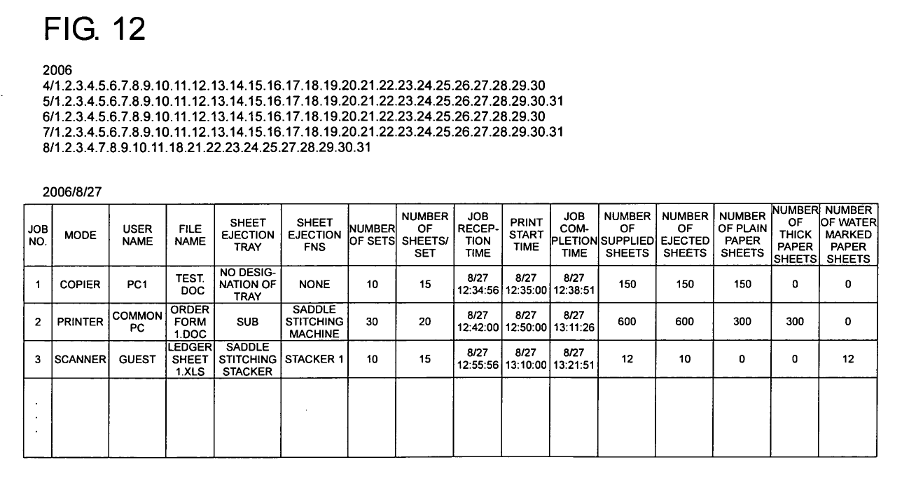

Next, an image forming apparatus, a print control apparatus and a print control method all relating to the Second Example of the invention will be described as follows, referring to FIG. 10-FIG. 12. FIG. 10 is a flow chart diagram showing processing in an image forming apparatus. FIG. 11 is a flow chart diagram showing processing in a print control apparatus. FIG. 12 is a diagram showing an example of the structure of control information.

In the First Example stated above, an occasion to control by using the number of supplied sheets for each tray was described. However, sheets to be used for printing include a special sheet such as documents of securities in addition to ordinary sheets for copy, and when the special sheets are loaded in plural trays to be used, use of only the number of supplied sheets for each tray makes it impossible to grasp the number of the special sheets used. In the present example, therefore, there is described an occasion where the number of sheets not for each tray but for each sheet type is controlled.

In that case, the structure of the image forming apparatus 20 is the same as that in FIG. 3, but, the storing device 26 stores correlating information that makes each tray and a sheet type of sheets loaded in that tray to correspond to each other. Incidentally, a sheet type mentioned in this specification means a type of sheets which is prescribed by sheet quality and sheet thickness as well as by presence of a watermark, and sheets each having a different size are included in the same sheet type.

Procedures of print control employing print control system 10 of the present example will be described as follows, referring to flow charts in FIG. 10 and FIG. 11.

First, in step S301 in FIG. 10, a user loads desired sheets into each tray of image forming apparatus 20, and in step S302, then, each tray and a sheet type of sheets loaded in that tray are made to correspond to each other, and the correlating information is stored in storing device 26. Meanwhile, let it be assumed in this case that sheet supply device 23 of image forming apparatus 20 has four trays, and special sheets (for example, high quality sheets and thick sheets as well as water marked sheets) are loaded in tray 1 and tray 2, while, ordinary sheets are loaded in tray 3 and tray 4.

Next, in step S303, control device 21 of image forming apparatus 20 monitors a job, and when a message of the job is received, an image is formed based on data of the job. Specifically, a photoconductor drum is irradiated by a semiconductor laser beam based on data to form a latent image, and charging, exposure and development processing are carried out, to form a toner image on the photoconductor drum. When forming an image based on a document placed on a document stand, on the other hand, an image may be formed by the use of data obtained by reading the document with an imaging device and by conducting prescribed processing.

Next, in step S305, control device 21 specifies the sheet based on information of the job, and selects the tray that houses therein the sheet based on the correlating information stored in storing device 26 in advance. For example, when the aforesaid special sheet is designated in the job, tray 1 (or tray 2) is selected.

Next, in step S306, sheet supply device 23 takes a sheet out of the selected tray and conveys it to print device 22. In that case, the number of supplied sheets is counted by sheet supply counters 23a-23d (sheet supply counter 23a of tray 1 in this particular case) arranged at prescribed positions on the conveyance path from the selected tray.

Next, in step S307, the print device 22 transfers a toner image existing on the photoconductor drum onto the sheet conveyed from sheet supply device 23, and fixes the toner image for printing.

Next, in step S308, the sheet ejection device 24 ejects the sheet onto which the image has been transferred to a fixed sheet ejection tray or a liftable sheet ejection tray, or ejects the sheet to a post-processing apparatus when post-processing is required. In that case, the number of ejected sheets is counted by sheet ejection counter 24a that is arranged at the prescribed position on the conveyance path.

Then, when transferring the same image onto plural sheets, processing of step S306 and processing of step S307 are repeated, and when transferring the succeeding image, processing of step S304—processing of S307 are repeated, and the number of supplied sheets and the number of ejected sheets are counted in succession, by sheet supply counters 23a-23d and by sheet ejection counter 24a.

Next, in step S309, sheet number information acquiring device 25 acquires counted values from sheet supply counters 23a-23d, calculates its increased number (a difference from the counted value after completion of the preceding job), then, acquires the number of supplied sheets for each tray and further acquires the counted value from sheet ejection counter 24a, and calculates its increased number (a difference from the counted value after completion of the preceding job) to acquire the number of ejected sheets. Further, information used for control of sheets (for example, information to specify the job and information to specify a user) is acquired in case of need.

In that case, image forming apparatus 20 is equipped with an ATS (Auto Tray Select) function, and when this ATS function is effective, and when the sheets of the same sheet type are loaded in plural trays, there is a function wherein when sheets in preceding tray (for example, tray 1) are used up, the tray is replaced automatically with a succeeding tray (for example, tray 2). When special 100 sheets loaded in tray 1 are used up and special 20 sheets loaded in tray 2 are supplied, because calculation of the number of supplied sheets for each tray by the sheet supply counter makes the later calculation complicated in this case, the value (100+20=120 in the aforesaid example) wherein the number of supplied sheets in the tray where sheets of the same sheet type are loaded is added in place of the number of sheets in each tray based on correlating information, is made to be the number of supplied special sheets, whereby, the number of sheets in view of the sheet can be controlled. Incidentally, even in the present example, it is possible to provide one sheet supply counter on the sheet supply device 23, and thereby to acquire the number of supplied sheets for each sheet type based on information of tray selected in step S305, the correlating information and the counted value by the sheet supply counter.

After that, in step S310, control device 21 transmits sheet number information including acquired sheet supply information and sheet ejection information for each sheet type to print control apparatus 30 by using communication device 27, and determines whether to terminate the processing in step S311 or not, and when the processing is not terminated, the control device 21 returns to step S303 to repeat the same processing for the succeeding job.

On the other hand, print control apparatus 30 receives sheet number information from image forming apparatus 20 by using communication device 35 in step S401 in FIG. 11, and determination device 32 compares the total value of the numbers of supplied sheets for each sheet type with the number of ejected sheets.

Then, in step S403, when the number of supplied sheets agrees with that of ejected sheets after the comparison, it is judged that the processing has been terminated correctly. When the number of supplied sheets does not agrees with that of ejected sheets, on the other hand, it is judged that print failures (loss and jam) occurred in step S404.

Next, in step S405, control information generating device 34 totals sheet number information for sheets transmitted for each job and results of determination made by determination device 32, and generates control information shown in FIG. 12. In this control information, there are described information for specifying a job (job number and mode, sheet ejection tray, sheet ejection FNS, job acceptance time, print starting time and job completion time), information for specifying a user (user name) and information for specifying a condition of use for sheets (number of supplied sheets for each sheet type, totaled number of sheets and number of ejected sheets), and with respect to the number of supplied sheets and the number of ejected sheets for the job that is determined to have print failures, they are displayed by changing colors and display forms so that the results of the determination may be discriminated. Meanwhile, although information for single image forming apparatus 20 is described in this case, information for plural image forming apparatuses 20 may also be described in a table. Then, the control information thus generated is stored in storing device 34 as a control information table for each job.

After that, in step S406, control device 31 of print control apparatus 30 transmits the control information to terminal 40 by using communication device 35, or, a user accesses print control apparatus 30 by utilizing terminal 40 to acquire control information, and grasps a situation of image forming apparatus 20 by referring to the control information. For example, in the example shown in FIG. 12, the number of supplied sheets and the number of ejected sheets for the third job do not agree with each other, which tells that print failures occurred on two special water marked sheets. Incidentally, the structure of the control information is not limited, and it is possible to arrange so that the control information is described in a markup language such as HTML or XML to be read by browser.

In the present example, sheet number information including the number of supplied sheets of each sheet type obtained from counted values of sheet supply counters 23a . . . provided on conveyance paths of respective trays and from correlating information and the number of ejected sheets obtained from sheet ejection counter 24a is outputted from image forming apparatus 20, print control apparatus 30 determines occurrence of print failures based on the aforesaid sheet number information, as stated above, thus, the control information which can be used by terminal 40 is generated, whereby, sheet supply can be controlled for each sheet type, and sheet number control for image forming apparatus 20 can be conducted simply and precisely.

In the meantime, a plurality of sheet ejection counters may also be provided on sheet ejection device 24, in the same way as in the First Example. Further, it is possible to provide a determination device and a control information generating device on image forming apparatus 20, and in this case, a print monitoring apparatus can be omitted.

### EXAMPLE 3

Next, an image forming apparatus, a print control apparatus and a print control method all relating to the Third Example of the invention will be described as follows.

The First and Second Examples described above employ the structure to control the number of supplied sheets for each tray and for each sheet type for all jobs. However, the sheet for the aforesaid loss control is usually limited to overprinting on an expensive sheet, and such control even for an ordinary sheet is a rare case. In addition, if all of the aforesaid pieces of information are displayed to be of equal rank, important sheet number information for loss is likely overlooked, and pressure on print control apparatus 30 caused by excessive data is further considered.

Therefore, information for each sheet type is controlled, and the aforesaid control is carried out only for necessary sheet type. In that case, the sheet types which need to be controlled are stored in storing device 26 of image forming apparatus 20, and control is carried out in control device 21 when the sheet type designated by the job agrees with the sheet type stored in the storing device 26. An explanation will be given below specifically.

### [When the Sheet Type is Designated by a Job]

A user sometimes makes a selection in terms not of a tray but of a sheet type, in copy and print. In this case, an operator sets a sheet to be controlled or a sheet not to be controlled with instruction such as “transmission is not necessary for ordinary sheet” or “transmission is necessary for document of securities”, in step S301 and step S302 in FIG. 10, and registers the setting information in storing device 26. After step S308 in FIG. 10, the sheet type designated by the job is compared with the sheet type thus registered, and when they agree with each other (or when they do not agree with each other), the sheet number is controlled in steps S309 and S310.

### [When the Tray is Designated by a Job]

When output is required under tray designation, the tray in which a special sheet is loaded is usually registered in advance. Therefore, a tray to be controlled or a tray not to be controlled is set with instruction such as “transmission is not necessary for tray 1” or “transmission is necessary for tray 2”, and registers the setting information in storing device 26. Then, the tray designated by the job is compared with the tray thus registered, and when they agree with each other (or when they do not agree with each other), the sheet number is controlled.

### [When Designated by a User at the Time of Printing]

A user sometimes makes judgment that sheet number control is necessary because this job is important for each job. In this case, the sheet number is controlled by user's instruction, independently of the sheet type. This instruction can be made through the ordinary designation of printer driver (checking necessary portions with a mouse).

### [When Designated for Each User]

There is a system that can output only after the certification of a user. In this case, printing is possible only when the password of the user registered in advance agrees. In this case, a user to be controlled or a user not to be controlled is set with instruction such as “transmission is not necessary for user 1” or “transmission is necessary for user 2” by controlling a level of importance of business for each user in advance, and that setting information is registered in storing device 26. Then, the identified user is compared with the registered user, and when both of them agree with each other (or when they do not agree), sheet number is controlled.

### [When Designating by a Program Job]

There is sometimes an occasion to set programs wherein special sheets are for the first half and ordinary sheets are for the second half, in spite of the same job. In this case, sheet number control is conducted only when special sheets.

In the present example, sheet number control is carried out only in the case of a sheet type, a tray and a user registered in advance, as stated above, whereby, it is possible to avoid a risk to overlook an important object to be controlled, to reduce loads caused by data processing and to conduct sheet number control for sheets effectively.

Incidentally, the invention is not limited to the description of the respective examples stated above, and the examples may be varied or modified, without departing from the spirit and scope of the invention.

The invention can be applied to any image forming apparatus, a print control apparatus for controlling the image forming apparatus, a control system including the aforesaid items and to a control method in the control system.

In the image forming apparatus, the print control apparatus and the print control method of the invention, the number of supplied sheets from each tray is calculated by providing sheet supply counters on conveyance paths from respective trays. Further, correlating information between each tray and a sheet type of sheets loaded in that tray is stored, and the number of supplied sheets of each sheet type is calculated based on the number of supplied sheets from each tray and on the correlating information, whereby, the number of sheets can be controlled simply and precisely.

Further, suitability of print is determined by comparing the number of supplied sheets with the number of ejected sheets and the control information displaying the number of supplied sheets and the number of ejected sheets and the results of the determination for each job is made to be capable of being utilized by an outer terminal, whereby, the number of sheets can be controlled simply and precisely.

Further, by registering a job, a user, a tray and a sheet type to be controlled or not to be controlled in advance, it is possible to carry out the control only for a special job (for example, printing of ledger sheets), a special user (for example, a user doing an important business), a special tray (for example, a tray in which valuable sheets are loaded) and a special sheet (for example, valuable securities document), thereby, it is possible to avoid a risk to overlook an important object to be controlled and to reduce loads caused by data processing.

What is claimed is:

1. An image forming apparatus comprising:
a sheet supply section for supplying a sheet from each of a plurality of trays, the sheet supply section including
a plurality of sheet supply counters for counting the number of sheets supplied from the each of trays,
the apparatus further comprising:
a printing section for printing on the sheet based on a job; and
a sheet ejection section for ejecting the printed sheet to a sheet ejection position, the sheet ejection section including
a sheet ejection counter for counting the number of sheets ejected to the sheet ejection position,
the apparatus further comprising:
a control section for acquiring, for each of the job, the number of sheets supplied from the each of trays, which is calculated based on a value of each of the sheet supply counters and the number of ejected sheets, which is calculated based on a value of the sheet ejection counter.

2. The image forming apparatus of claim 1, further comprising:
a storing section for registering, in advance, a tray among the plurality of trays which is controlled or a sheet type which is controlled,
wherein the control section, when a tray or a sheet type designated for the job has been registered in the storing section, acquires the number of sheets supplied from the each of trays and the number of ejected sheets.

3. The image forming apparatus of claim 1, further comprising:
a storing section for registering, in advance, a user who is controlled,
wherein the control section, when a user who executes the job has been registered in the storing section, acquires the number of sheets supplied from the each of trays and the number of ejected sheets.

4. The image forming apparatus of claim 1, further comprising:
a storing section for registering, in advance, a tray among the plurality of trays which is not controlled or a sheet type which is not controlled,
wherein the control section, when a tray or a sheet type designated for the job has not been registered in the storing section, acquires the number of sheets supplied from the each of trays and the number of ejected sheets.

5. The image forming apparatus of claim 1, further comprising:
a storing section for registering, in advance, a user who is not controlled,
wherein the control section, when a user who executes the job has not been registered in the storing section, acquires the number of sheets supplied from the each of a plurality of trays and the number of ejected sheets.

6. The image forming apparatus of claim 1, further comprising:
a determination section for determining presence or absence of print failure based on whether or not a total of numbers of sheets supplied from the each of trays agrees with the number of ejected sheets; and
a control information generating section for generating control information including the number of sheets supplied from the each of trays, the total of numbers of sheets, the number of ejected sheets and a result of the determination.

7. An image forming apparatus comprising:
a sheet supply section for supplying a sheet from each of a plurality of trays, the sheet supply section including
a plurality of sheet supply counters for counting the number of sheets supplied from the each of trays,
the apparatus further comprising:
a printing section for printing on the sheet based on a job; and
a sheet ejection section for ejecting the printed sheet to a sheet ejection position, the sheet ejection section including
a sheet ejection counter for counting the number of sheets ejected to the sheet ejection position,
the apparatus further comprising:
a first storing section for storing correlating information which correlates the each of trays with a sheet type of a sheet housed in the each of trays; and
a control section for acquiring, for each of the job, the number of sheets of each the sheet type, which is calculated based on a value of each of the sheet supply counters and based on the correlating information, and the number of ejected sheets, which is calculated based on a value of the sheet ejection counter.

8. The image forming apparatus of claim 7, further comprising:
a storing section for registering, in advance, a tray among the trays which is controlled or a sheet type which is controlled,
wherein the control section, when a tray or a sheet type designated for the job has been registered in the storing section, acquires the number of sheets of each the sheet type and the number of ejected sheets.

9. The image forming apparatus of claim 7, further comprising:
a storing section for registering, in advance, a user who is controlled,
wherein the control section, when a user who executes the job has been registered in the storing section, acquires the number of sheets of each the sheet type and the number of ejected sheets.

10. The image forming apparatus of claim 7, further comprising:
a storing section for registering, in advance, a tray among the trays which is not controlled or a sheet type which is not controlled,
wherein the control section, when a tray or a sheet type designated for the job has not been registered in the storing section, acquires the number of sheets of each the sheet type and the number of ejected sheets.

11. The image forming apparatus of claim 7, further comprising:
a storing section for registering, in advance, a user who is not controlled,
wherein the control section, when a user who executes the job has not been registered in the storing section, acquires the number of sheets of each the sheet type and the number of ejected sheets.

12. The image forming apparatus of claim 7, further comprising:
a determination section for determining presence or absence of print failure based on whether or not a total of numbers of supplied sheets of each the sheet type agrees with the number of ejected sheets; and
a control information generating section for generating control information including the number of sheets of each the sheet type, the total of numbers of supplied sheets, the number of ejected sheets and a result of the determination.

13. A print control apparatus which controls one or a plurality of image forming apparatuses having a plurality of trays, the print control apparatus comprising:
determination section for receiving information of, at least, the number of sheets supplied from each of the trays and the number of ejected sheets and for determining presence or absence of print failure based on whether or not a total of numbers of sheets supplied from each of the trays agrees with the number of ejected sheets; and
a control information generating section for generating control information including the number of sheets supplied from each of the trays, the total of numbers of sheets, the number of ejected sheets and a result of the determination.

14. A print control apparatus which controls one or a plurality of image forming apparatuses having a plurality of trays, the print control apparatus comprising:
a determination section for receiving information of, at least, the number of supplied sheets of each sheet type and the number of ejected sheets and for determining presence or absence of print failure based on whether or not a total of numbers of supplied sheets of the each sheet type agrees with the number of ejected sheets; and
a control information generating section for generating control information including the number of sheets of the each sheet type, the total of numbers of supplied sheets, the number of ejected sheets and a result of the determination.

15. An print control method for a system including one or a plurality of image forming apparatuses, each of the apparatuses comprising:
a sheet supply section for supplying a sheet from each of a plurality of trays, the sheet supply section including
a plurality of sheet supply counters for counting the number of sheets supplied from the each of trays,
the each the of apparatuses further comprising:
a printing section for printing on the sheet based on a job; and
a sheet ejection section for ejecting the printed sheet to a sheet ejection position, the sheet ejection section including
a sheet ejection counter for counting the number of sheets ejected to the sheet ejection position,
the print control method comprising steps of:
acquiring, for each of the job, the number of sheets supplied from the each of trays, which is calculated based on a value of each of the sheet supply counters and the number of ejected sheets, which is calculated based on a value of the sheet ejection counter;
determining presence or absence of print failure based on whether or not a total of numbers of sheets supplied from the each of trays agrees with the number of ejected sheets; and
generating control information including the number of sheets supplied from the each of trays, the total of numbers of sheets, the number of ejected sheets and a result of the determination.

16. The print control method of claim 15, further comprising steps of:
registering, in advance, a tray among the trays which is controlled or a sheet type which is controlled,
wherein in the acquiring step, when a tray or a sheet type designated for the job has been registered in the storing section, the number of sheets supplied from the each of trays and the number of ejected sheets are acquired.

17. The print control method of claim 15, further comprising steps of:
registering, in advance, a user who is controlled,
wherein in the acquiring step, when a user who executes the job has been registered in the storing section, the number of sheets supplied from the each of a plurality of trays and the number of ejected sheets are acquired.

18. An print control method for a system including one or a plurality of image forming apparatuses, each of the apparatuses comprising:
a sheet supply section for supplying a sheet from each of a plurality of trays, the sheet supply section including
a plurality of sheet supply counters for counting the number of sheets supplied from the each of trays,
the each of the apparatuses further comprising:
a printing section for printing on the sheet based on a job; and
a sheet ejection section for ejecting the printed sheet to a sheet ejection position, the sheet ejection section including
a sheet ejection counter for counting the number of sheets ejected to the sheet ejection position,
the print control method comprising steps of:
storing correlating information which correlates the each of trays with a sheet type of a sheet housed in the each of trays;
acquiring, for each of the job, the number of supplied sheets of each the sheet type, which is calculated based on a value of each of the plurality of sheet supply counters and based on the correlating information, and the number of ejected sheets, which is calculated based on a value of the sheet ejection counter;
determining presence or absence of print failure based on whether or not a total of numbers of supplied sheets of each the sheet type agrees with the number of ejected sheets; and
generating control information including the number of sheets of each the sheet type, the total of numbers of supplied sheets, the number of ejected sheets and a result of the determination.

19. The print control method of claim 18, further comprising steps of:
registering, in advance, a tray among the trays which is controlled or a sheet type which is controlled, in a storing section,
wherein in the acquiring step, when a tray or a sheet type designated for the job has been registered in the storing section, the number of sheets of each the sheet type and the number of ejected sheets are acquired.

20. The print control method of claim 18, further comprising steps of:
registering, in advance, a user who is controlled, in a storing section,
wherein the acquiring step, when a user who executes the job has been registered in the storing section, the number of sheets of each the sheet type and the number of ejected sheets are acquired.
